(19) United States
(12) Patent Application Publication
(10) Pub. No.: US 2016/0304359 A1
(43) Pub. Date: Oct. 20, 2016

(54) FILTERING DEVICE WITH FLOW REDUCTION

(71) Applicant: Whirlpool Corporation, Benton Harbor, MI (US)

(72) Inventors: Nihat Cur, St. Joseph, MI (US); James C.L. Guarino, Kalamazoo, MI (US); Steven J. Kuehl, Stevensville, MI (US); Mark M. Senninger, St. Joseph, MI (US)

(21) Appl. No.: 15/131,964

(22) Filed: Apr. 18, 2016

Related U.S. Application Data
(60) Provisional application No. 62/149,195, filed on Apr. 17, 2015.

(51) Int. Cl. C02F 1/28; F25D 23/12; B01D 15/10

(52) U.S. Cl. CPC C02F 1/283; B01D 15/10; F25D 23/12; C02F 2307/12

(57) ABSTRACT

A method of indicating to a user of an appliance that a water filter unit operably connected to the appliance has passed its useful life that includes the steps of: providing a filter unit and wherein the filter unit comprises a fluid flow impeding system within a housing of the filter unit; engaging the filter unit with the appliance; measuring the volume of water treated by the filter unit using an end of life measuring system positioned within the filter unit; and activating the fluid flow impeding device contained within the housing of the filter unit after a maximum volume of water the filter unit has been designed to treat has been surpassed.

### CROSS-REFERENCE TO RELATED APPLICATION

This application claims priority to U.S. Application No. 62/149,195, filed on Apr. 17, 2015, entitled “FILTERING DEVICE WITH GEARED FLOW REDUCTION WITH FLOW BY-PASS,” the disclosure of which is hereby incorporated herein by reference in its entirety.

### BACKGROUND OF THE DISCLOSURE

The present disclosure is generally related to a filtration system, more specifically, to a filtration system that includes one or more systems configured to reduce, stop or otherwise alter fluid flow. The water flow is altered to indicate expiration of a filter unit after the filtration system's useful life has passed. The filtration system is typically a water filtration system, more typically a water filtration systems used in connection with an appliance. The appliance is typically a refrigerator.

Gearing systems have been contemplated to be used in connection with measuring water flow through a water filter. However, these systems have been, prior to the various solutions of the present disclosure, impractical when used in connection with refrigerator filter systems because the gear train mechanism would require fine tolerance on the gear train stack and it would be difficult to manufacture a system for the large volume of water to be measured by a refrigerator water filter, approximately 600 US gallons. Prior faucet based gearing systems for totaling water flow measure a volume, which is typically a maximum of up to 25 US gallons.

### SUMMARY

An aspect of the present disclosure is generally directed to a method of indicating to a user of an appliance that a water filter unit operably connected to the appliance has passed its useful life. The method typically includes the steps of: providing a filter unit that includes a fluid flow impeding system within a housing of the filter unit; engaging the filter unit with the appliance in a manner such that water received into the appliance from an exterior water source from the appliance enters the filter unit through an inlet aperture and filtered water is delivered out an outlet aperture; measuring the volume of water treated by the filter unit using an end of life measuring system positioned within the filter unit where the end of life measuring system includes a by-pass water line that diverts a minority portion of the water received by the filter unit from the exterior water source into engagement with a gear train system that is operably engaged with a fluid flow impeding device; and activating the fluid flow impeding device contained within the housing of the filter unit after a maximum volume of water the filter unit has been designed to treat has been surpassed.

Yet another aspect of the present disclosure is generally directed to a filter unit that includes: a substantially cylindrically shaped main body portion having a distal end portion and an engaging end portion configured to engage a water source and receive water from the water source through a water inlet aperture and deliver treated water out of the filter unit through a water outlet aperture; and a fluid flow impeding system positioned in at least one of (1) the distal end portion or (2) the engaging end portion of filter unit; and where the fluid flow impeding system is spaced within the main body portion such that water passing from the water inlet aperture and out the water outlet aperture passes through the fluid flow impeding system. The fluid flow impeding system is configured to be activated after a predetermined volume of water has passed through the fluid flow impeding system and thereafter position a fluid flow impeding object into the water flow and thereby slow the flow of water through the water impeding valve to a rate less than the normal flow rate and after the predetermined volume of water has passed through the fluid impeding system. The fluid flow impeding system includes a gear based flow totaler assembly having a gear stack in operable connection with a diverted water flow within a diverted water flow pathway that is a minority of the water flowing through the main water flow pathway in the filter where the minority of water flowing through the main water flow pathway and the gear stack are configured to measure when the effective useful life of the filter unit has been surpassed.

Yet another aspect of the present disclosure is generally directed to an appliance that includes: at least one freezer compartment; at least one fresh food compartment; an exterior water connection that provides water from outside the appliance to the appliance; a filter unit; and a filter head assembly configured to receive a filter unit wherein the filter unit is configured to be engaged and disengaged with the filter head assembly by hand and without the use of tools. The filter unit includes: a main body portion having a distal end portion and an engaging end portion configured to engage a water source and receive water from the water source through a water inlet aperture and deliver treated water out of the filter unit through a water outlet aperture; and a fluid flow impeding system positioned in at least one of (1) the distal end portion or (2) the engaging end portion of filter unit. The fluid flow impeding system is typically engaged with an interior wall of the main body portion such that water passing from the water inlet aperture and out the water outlet aperture passes through the fluid flow impeding system. The fluid flow impeding system includes a gear based flow totaler assembly that includes a gear stack in operable connection with a diverted water flow within a diverted water flow pathway that is a minority of the water flowing through the main water flow pathway in the filter where the minority of water flowing through the main water flow pathway and the gear stack are configured to measure when the effective useful life of the filter unit has been surpassed. The water filter has a useful life capacity such that the filter is able to filter greater than 200 gallons of unfiltered municipal water prior to losing its efficacy and the water filter includes an activated carbon filtration media that reduces chlorine, taste and odor components (CTO) per NSF 42 and NSF Standard 53 to a minimum of 200 gallons. The fluid flow impeding system and the gear based flow totaler are each typically free of any electronically powered component.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an elevated front view of an exemplary filter unit according to an aspect of the present disclosure;

FIG. 2 is an exploded view of the structural components of the filter unit of FIG. 1;

FIG. 3 is an elevated end view of the filter unit of FIG. 1;

FIG. 4 is a cross-sectional view of the filter unit taken along the line IV-IV in FIG. 3;

FIG. 5 is an exploded view of a fluid flow impeding system according to an aspect of the present disclosure;

FIG. 6 is a dual cut away view of the fluid flow impeding system as shown in FIG. 5 in an assembled form;

FIG. 7 is a cross-sectional view of the fluid flow impeding system within the filter unit without the protective material over the electronic components of the system;

FIG. 8 is a cross-sectional view of the fluid flow impeding system within the filter unit with the protective material over the electronic components of the system;

FIG. 9 is a cross-sectional bottom view of the fluid flow impeding system including the electrical components of the system;

FIG. 10 is a cross-sectional top view of the fluid flow impeding system according to an aspect of the present disclosure;

FIG. 11 is a perspective view of an electrical system according to an aspect of the present disclosure;

FIG. 12 is a perspective view of an electrical system according to an aspect of the present disclosure;

FIG. 13 is an elevated front view of the electrical system of FIG. 12;

FIG. 14 is a perspective view of the impeller according to an aspect of the present disclosure;

FIG. 15 is a front elevational view of the impeller of FIG. 14;

FIG. 16 is a perspective view of an impeller according to another aspect the present disclosure;

FIG. 17 is a front perspective view of an impeller according to another aspect of the present disclosure;

FIG. 18 is a front perspective view of the impeller of FIG. 16;

FIGS. 19A-D are each a front perspective view of different configurations of valve feed inserts with various by-pass configurations that allow some amount of flow to continue through the filter unit, but at a reduced rate;

FIG. 20A is a cross-sectional perspective view of a fluid flow impeding system according to an aspect of the present disclosure prior to the expiration of the useful life of the filter unit;

FIG. 20B is a cross-sectional perspective view of a fluid flow impeding system according to an aspect of the present disclosure after the useful life of the filter unit showing impeded or stopped flow of water through the filter unit;

FIG. 21A is a cross-sectional perspective view of an alternative fluid flow impeding system according to an aspect of the present disclosure prior to the expiration of the useful life of the filter unit;

FIG. 21B is a cross-sectional perspective view of an alternative fluid flow impeding system according to an aspect of the present disclosure prior to expiration after the useful life of the filter unit showing impeded or stopped flow of water through the filter unit;

FIG. 22 is a dual cut away perspective view of a fluid flow impeding system according to an aspect of the present disclosure generally showing water flow into and out of the system;

FIG. 23 is a dual cut away perspective view of a fluid flow impeding system and according to an aspect of the present disclosure generally showing water flow into and out of the system showing a more detailed view of water flow as it passes through the fluid flow impeding system, through the filter and out the center outlet;

FIG. 24 is a cross-sectional view of a filter unit according to an aspect of the present disclosure with the small black arrows showing the water flow path through the system;

FIG. 25 is a bottom left perspective view of an embodiment of a fluid flow impeding system according to an aspect of the present disclosure;

FIG. 26 is a front elevational view of the housing of FIG. 25 showing the electronic component insulated by a waterproof insulated material;

FIG. 27 is a front elevational view of the housing of FIG. 25 showing the circular water flow direction through an impeller if it were inserted into the system;

FIG. 28 is a perspective view of the housing shown in FIG. 27 with an impeller, according to an aspect of the present disclosure, fitted within the housing;

FIG. 29 is a front left perspective view of the housing of FIGS. 25-28 with an impeller cover cap positioned over the impeller;

FIG. 30A is a cross-sectional perspective view of a fluid impeding system according to another aspect of the present disclosure prior to the expiration of the useful life of the filter unit using a flap valve to initially permit water flow;

FIG. 30B is a cross-sectional perspective view of a fluid impeding system according to another aspect of the present disclosure after the expiration of the useful life of the filter unit using a flap valve showing the valve in the closed position to inhibit water flow;

FIG. 31A is a cross-sectional perspective view of a fluid impeding system according to another aspect of the present disclosure prior to the expiration of the useful life of the filter unit using a plurality of beads suspended in strands;

FIG. 31B is a cross-sectional perspective view of a fluid impeding system according to another aspect of the present disclosure prior to the expiration of the useful life of the filter unit where the suspended strands of beads shown in FIG. 31A have been released to inhibit water flow;

FIG. 32A is a cross-sectional perspective view of a fluid impeding system according to another aspect of the present disclosure prior to the expiration of the useful life of the filter unit using magnetic beads, typically metallic spherical beads, or other debris engaged to a magnet to initially permit water flow;

FIG. 32B is a cross-sectional perspective view of a fluid impeding system according to another aspect of the present disclosure prior to the expiration of the useful life of the filter unit where the magnetic beads or debris have been released to inhibit water flow;

FIG. 33 is a circuit design according to an aspect of the present disclosure where the solenoid may be used without a capacitor.

FIG. 34 is an enlarged cross-sectional view of a fluid impeding system according to another aspect of the present disclosure employing a solenoid and plunger/peg system to restrict flow through the filter;

FIG. 35 is a cross-sectional view of the fluid impeding system shown in FIG. 34 spaced within the filter with the arrows showing general water flow through the filter;

FIG. 36 is a cross-sectional view of the fluid impeding system shown in FIGS. 34 and 35 with the plunger triggered and seated inside a raised ring thereby restricting water flow through a small (about 0.5 mm diameter) hole in the plunger;

FIG. 37 is schematic cut-away view of a refrigerator filter with a gear-based flow totaler in place showing a balancing restriction on the by-pass line;

FIG. 38 is a schematic cut-away view of a refrigerator water filter with gear-based flow totaler in place and a venturi-driven pressure differential;

FIG. 39A shows a schematic view of a shape memory alloy in a relaxed state in the water flow/inactivated position;

FIG. 39B shows a shape memory alloy in the activated/deployed position impeding water flow through the water path;

FIG. 40A shows an alternative embodiment where the shape memory alloy is the relaxed state and the perforated plate is in the retracted position;

FIG. 40B shows the shape memory alloy in the trained shape state/activated state and the perforated plate in the water impeding position.

FIG. 41 is a cross-sectional top view of a filter showing a fuse system that is isolated from water flow but in the water flow pathway;

FIG. 42 is a cross-sectional bottom view of the aspect of the present disclosure shown in FIG. 41 and FIG. 43; and

FIG. 43 is a front, elevated, cross-sectional view taken along lines XLIII in FIG. 41.

### DETAILED DESCRIPTION

Before the subject disclosure is described further, it is to be understood that the disclosure is not limited to the particular embodiments of the disclosure described below, as variations of the particular embodiments may be made and still fall within the scope of the appended claims. It is also to be understood that the terminology employed is for the purpose of describing particular embodiments, and is not intended to be limiting. Instead, the scope of the present disclosure will be established by the appended claims.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure.

In this specification and the appended claims, the singular forms “a,” “an” and “the” include plural reference unless the context clearly dictates otherwise.

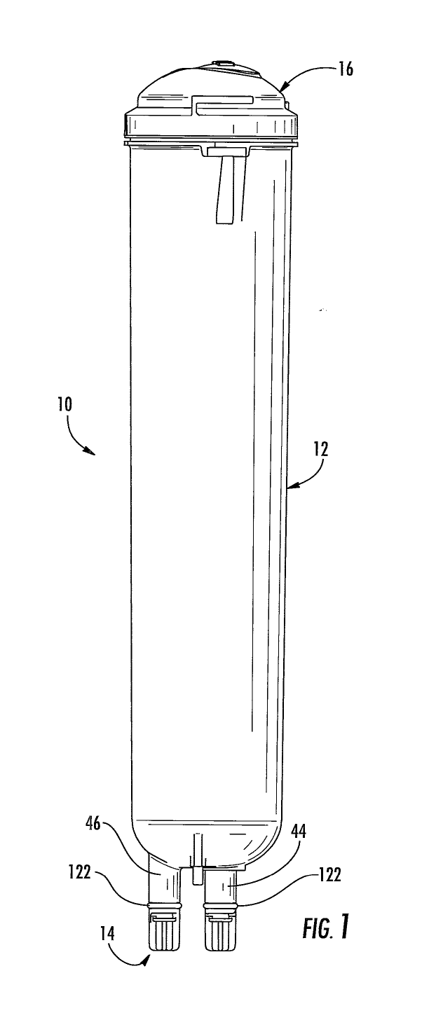

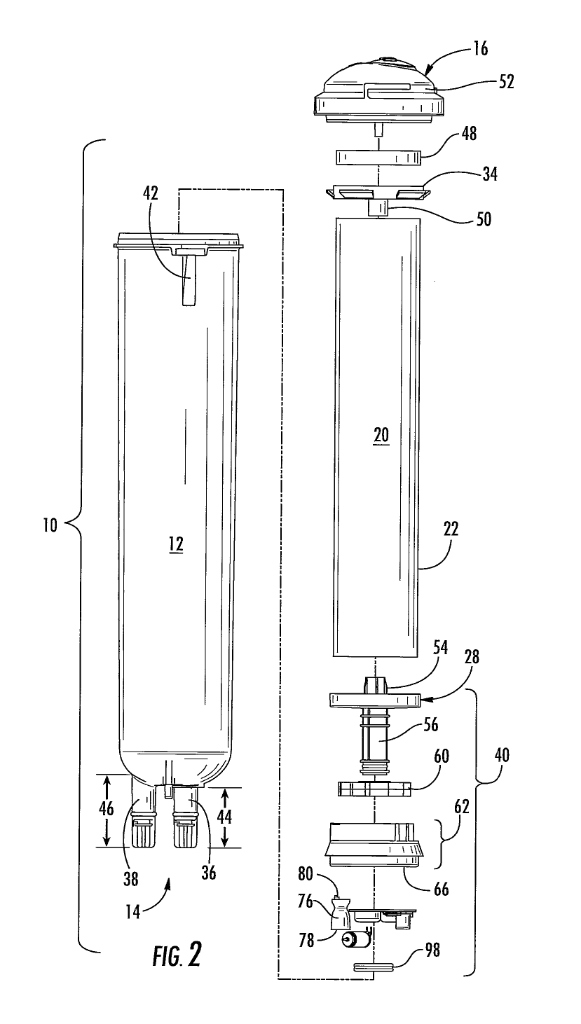

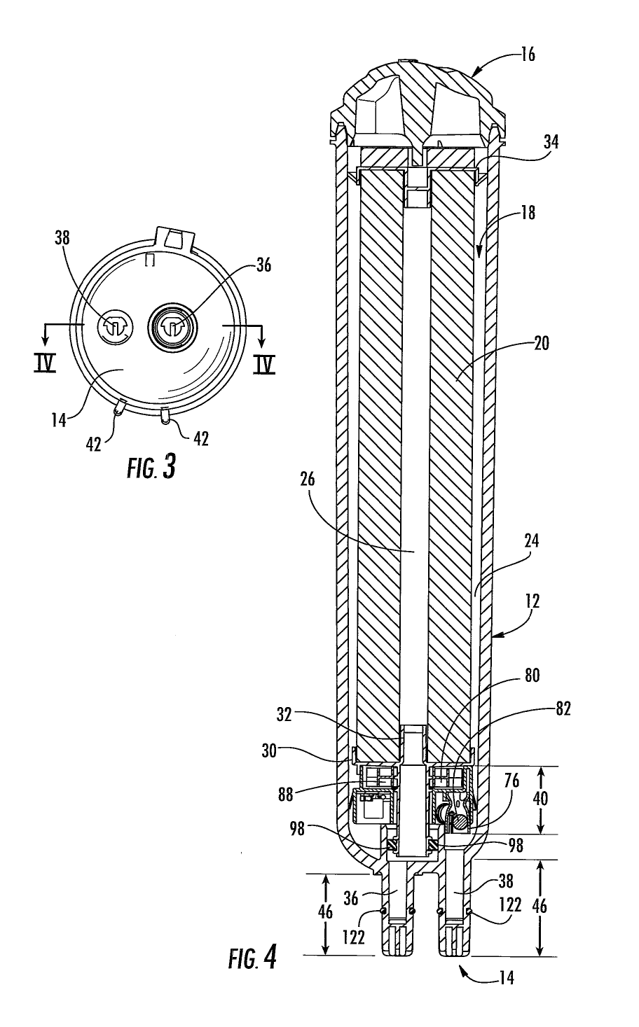

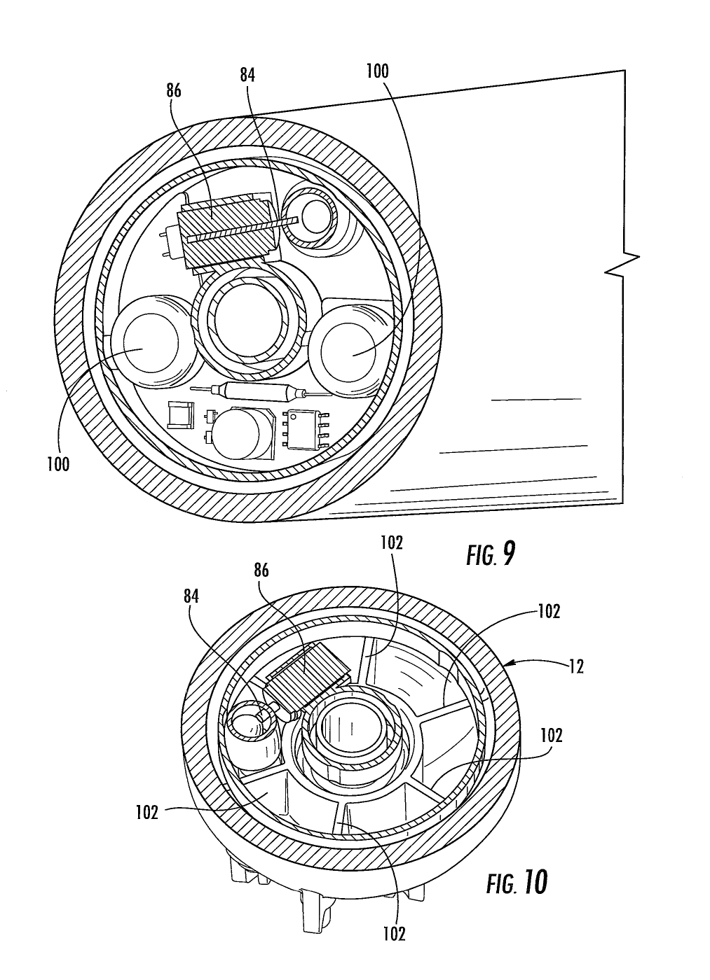

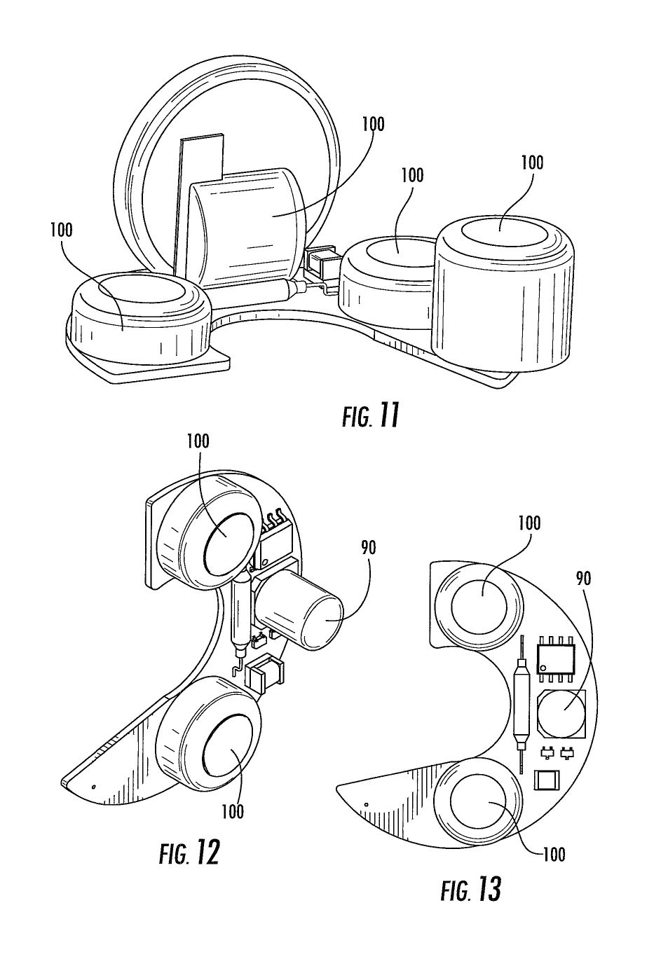

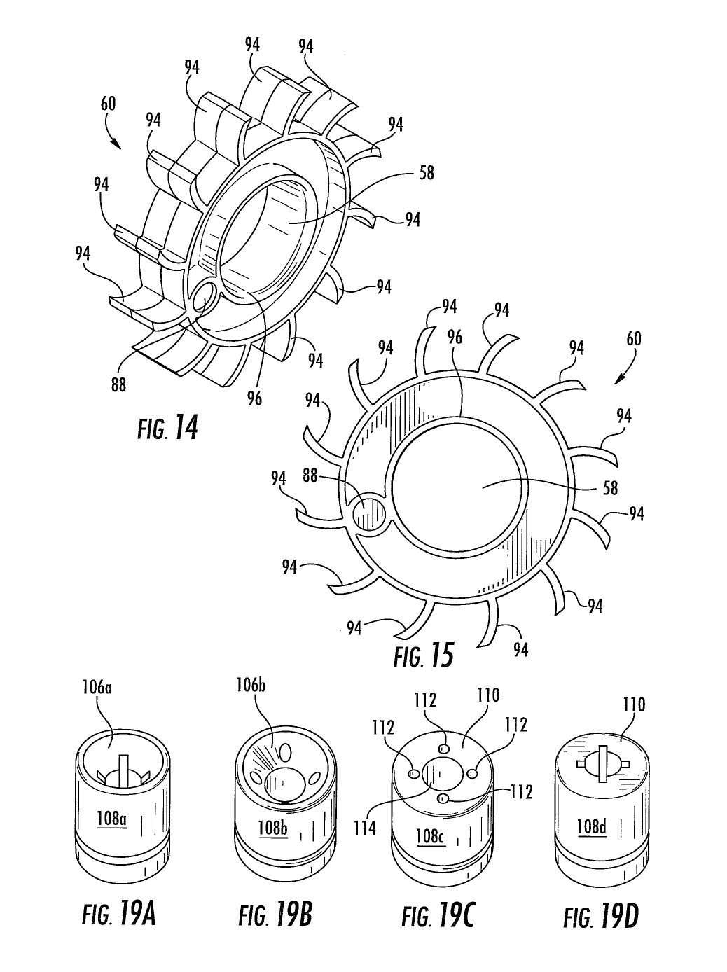

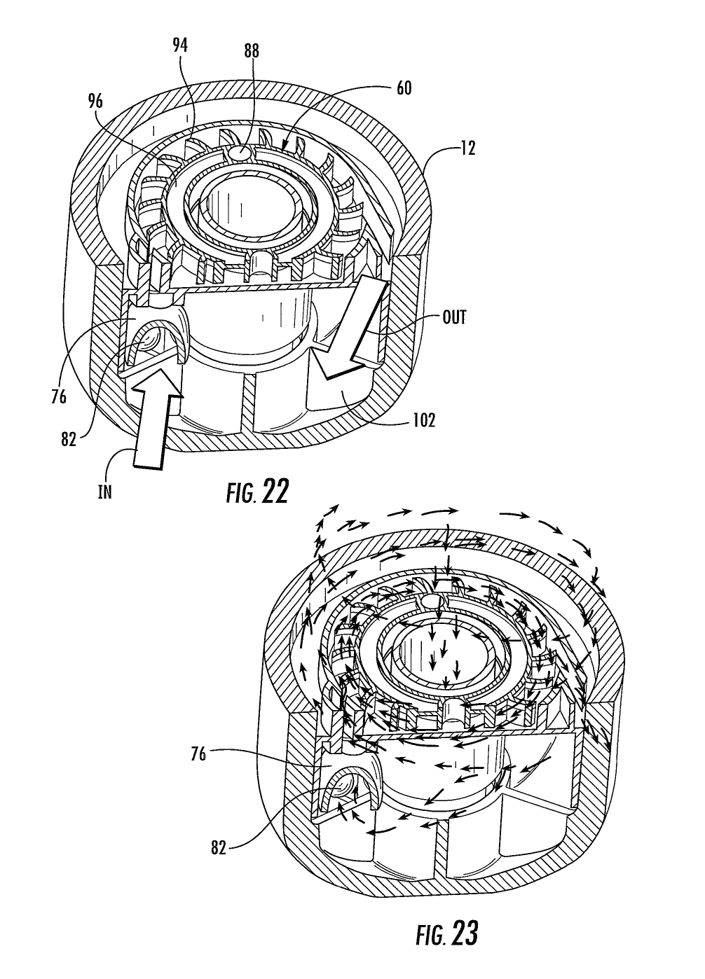

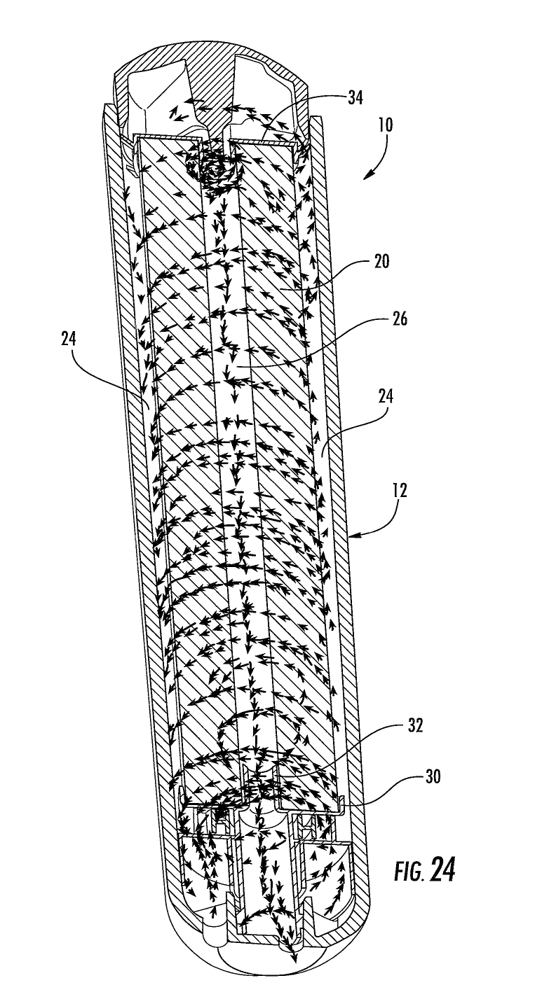

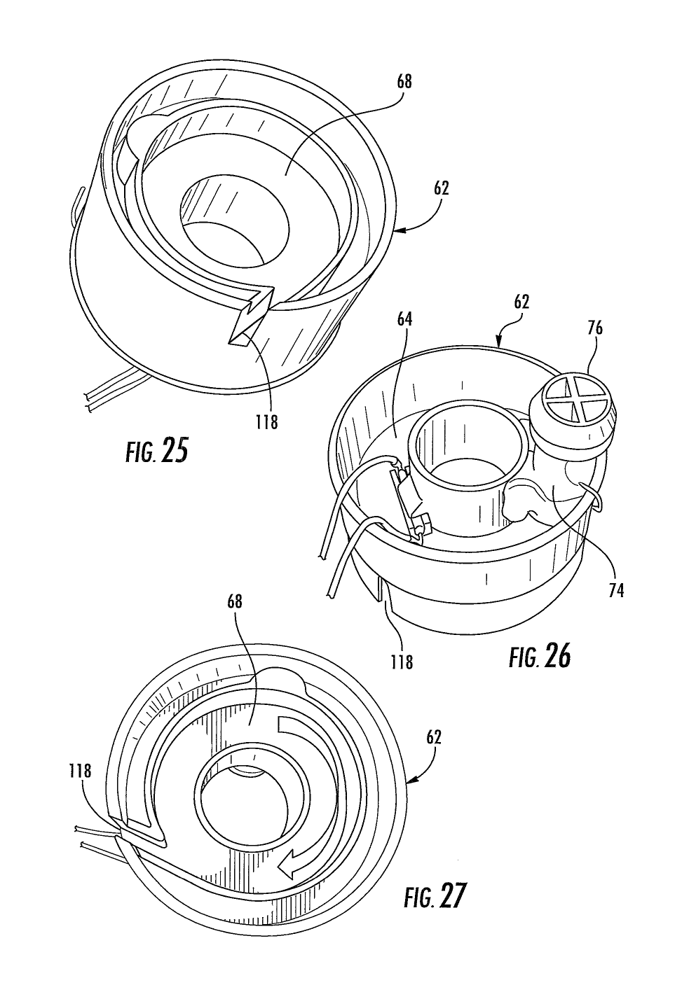

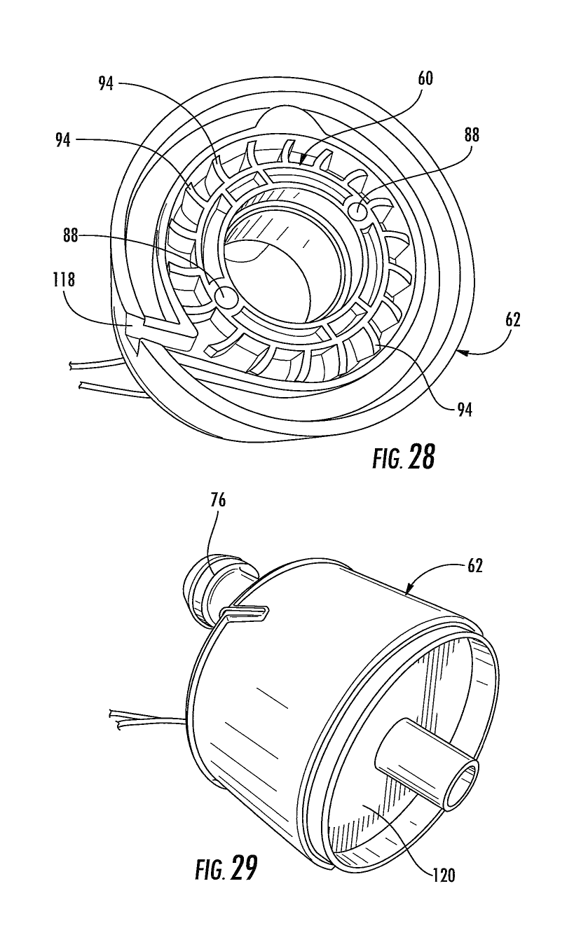

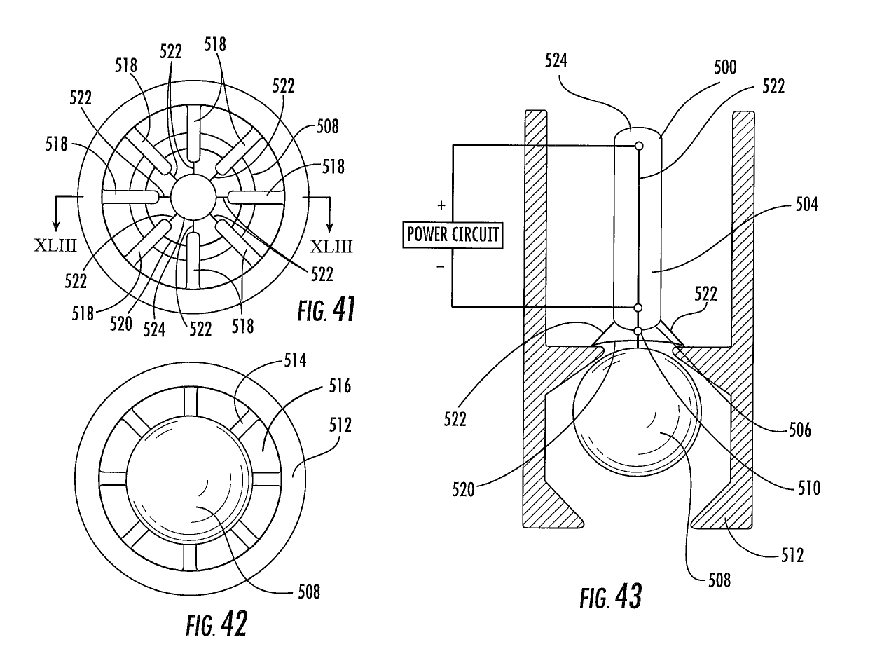

Referring to FIGS. 1-43, a filtration system is generally employed. The filtration system typically includes a filter unit 10 (see FIG. 1). The filter unit typically includes a cylindrical body portion 12 with a water receiving and emitting end 14 and a distal end 16. The filter unit defines an interior volume within the cylindrical body portion between the water receiving and emitting end and the distal end. The filter unit includes a filter media portion 20 disposed within the interior volume 18 (see FIGS. 2-4). The filter media portion has a permeable media wall 22 is spaced away from the body portion 12 and defines an exterior passage 24 between the permeable media wall 22 and the body portion 12. The permeable media wall 22 typically surrounds the central axis of the filter media portion 20 and defines an interior passage 26. A filter media engaging cap 28 is typically coupled between the water receiving and emitting end 14 of the filter unit and the body portion 12. The filter media engaging cap 28 typically has a cylindrical filter media engaging trough portion defined by an outer wall 30 and an upwardly extending central axis channel 32. The upwardly extending central axis channel 32 is typically cylindrically shaped in size to matingly engage the interior passage of the filter media portion 20. A second cap 34 also typically contains a filter media engaging portion trough section. The second cap 34 is typically spaced at the opposing end of the filter media portion. The interior passage 26 extends through the filter media engaging cap 28 and operably couples with the outlet aperture 36 to dispense filtered liquid, typically filtered water.

An inlet aperture 38 is operably coupled with the fluid flow impeding system 40 and the exterior passage 24 to deliver unfiltered (unfiltered by the filter unit 10) water into the interior volume of the filter unit 10. The water in the exterior passage passes through and is treated by the filter media portion 20. The filter media engaging cap 28 and the second cap 34 prevent unfiltered from passing from the exterior passage 24 to the interior passage 26 without passing through the filter media portion 20.

The fluid flow impeding system 40 operates to measure the amount (volume) of water passing through the filter unit 10 being delivered as filtered water to the end user. Upon passing of the service life of the filter media portion 20 or the approximate service life of the filter media portion 20, the fluid flow impeding system 40 operates to impede (reduce the flow rate) or stop the flow of fluid through the system. A fluid flow impeding system, according to the present disclosure, may operate to allow some flow of unfiltered water to flow at a normal rate followed by an impeded or stopped flow shortly thereafter to repeatedly demonstrate to the user upon each use that the filter media portion has passed its service life to effectively filter unwanted material from the fluid/water. In this manner, the user is repeatedly notified that the filter has expired while not believing that there is a problem with the system, such as a clogged water conduit in the appliance or other overall problem with the appliance engaged with the filter unit.

As shown in various figures, O-rings 122 are used in various locations of the filter unit to ensure a sealing connection between components.

The filter unit 10 is typically positioned within a refrigerator appliance according to one aspect of the present disclosure. The refrigerator appliance typically includes an insulated cabinet forming at least one interior freezer compartment and at least one interior refrigerator compartment cooled with at least one refrigeration circuit. The freezer compartment may be arranged below and be separate from the refrigerator compartment and enclosed with a slidable drawer having an insulated door. The freezer compartment may also alternatively be arranged relative to the refrigerator compartment in a side-by-side configuration or with the freezer compartment on top of the refrigerator compartment. In any configuration, the compartments may be accessible by opening and closing hinged doors by hand without use of tools by a person grasping and pulling on a handle on each of the doors. The refrigerator compartment may be enclosed with two hingeable doors in a side-by-side style door arrangement. The left refrigerator door may also include an interactive display, a water dispenser, and an ice dispenser that receives ice from an ice maker positioned somewhere within the appliance or proximate the appliance. The right refrigerator door is also capable of being positioned in an open position when the door is pivoted away from the side wall of the insulated cabinet to expose the interior refrigerator compartment. The refrigerator compartment may also include an alternative enclosure and an alternative location configuration relative to the freezer compartment. It is also conceivable that the refrigerator appliance may alternatively be an appliance with one or more refrigerator compartments and no freezer compartments or only one or more freezer compartments and no refrigerator compartments.

In each embodiment, the appliance may or may not have an ice dispenser or water dispenser, but typically the appliance will have both an ice dispenser and water dispenser. The filter unit 10 is typically operably connected to the appliance to receive water from a water distribution system of the appliance. The water distribution system typically includes a connector on a rear surface of the insulated cabinet of the appliance that couples the appliance with an external water source to supply a water flow to the filter unit 10. Typically, the water supply is a municipal water source or well water source. While the water supply supplied to the appliance prior to being treated by the filter unit 10 may be filtered prior to being treated by the filter unit 10, the water source typically provides unfiltered water to the filter unit 10.

The filter unit typically engages the appliance via a filter head assembly in either a lower grill area on the bottom typically the bottom right below the freezer compartment or an upper panel area above the refrigerator compartment, most typically on the top interior surface of the refrigerator compartment. However, it is conceivable that the filter unit may engage the appliance at any location within or on the exterior surface of the appliance. Further, the filter unit 10 may be used in other applications including other appliances that store, use or dispense any liquid in need of filtration. The liquid to be treated is typically drinking water or water used to form ice. Additionally, the filter unit 10 may be used in connection with a household or standard tap water faucet. When engaged with such a faucet, the engagement is typically at or proximate the faucet outlet or other domestic water source. However, it is conceivable that the filter could be installed intermediate within the water piping of the faucet line between the faucet outlet and the water source.

The body portion 12 of the filter unit 10 is typically cylindrically shaped with a diameter that is capable and configured to be grasped by a hand of a user. Often one or more grasping cutouts or protrusions 42 are included on the exterior surface of the body portion 12. Most typically, the grasping cutouts or protrusions are proximate the distal end 16 (see FIG. 2). This provides a gripping surface for the user to engage and disengage the filter unit from the filter head assembly, which is typically done by rotational and longitudinal movement of the filter unit relative to the filter head assembly.

The filter head assembly typically includes a filter receiving end and water receiving end. The filter receiving end typically has a cylindrical receiver adapted to receive all or at least a portion of the water receiving and emitting end 14 of the filter unit 10. The cylindrical receiver may include an electrical connector that is adapted to engage with and provide electricity and data communication with at least one electronic device that communicates with the filter unit. The cylindrical receiver of the filter head assembly may also include a securing clip that couples with the exterior surface of the body portion 12 of the filter unit 10.

The water receiving end of the filter head assembly typically includes an inlet and an outlet laterally extending on opposite sides of the filter head assembly. The inlet generally couples with the water source via at least one water line that receives water flow from outside the appliance, typically unfiltered water from outside the appliance. In addition, the outlet generally couples with the water dispenser and/or the ice maker within the appliance via at least one water conduit line, typically unfiltered water to the ice maker or for consumption or use by the user. The inlet and outlet of the filter head assembly can be at any angle relative to one another and disposed at any location on the filter head assembly to connect the inlet aperture and the outlet aperture of the filter unit 10.

The filter unit 10 may have a single engagement protrusion that is typically an oval cross-sectional shape (not shown in the drawings). The engagement protrusion extends longitudinally from the water receiving and emitting end in general alignment with the longitudinal extent of the body portion 12. The engagement protrusion is generally disposed at an offset location on the water receiving and emitting end according to this embodiment of the present disclosure, substantially aligning the outlet aperture with the central axis of the body portion 12. The body portion 12, in this embodiment, typically includes a laterally extending key member that is configured to slidably engage a helical shaped slot on the interior surface of the cylindrical receiver of the filter head assembly to engage the filter unit therewith. Similarly, the body portion includes a helically shaped retention slot to slidably engage a retention member on the filter head assembly. The entire disclosure of U.S. Pat. No. 8,580,109 is incorporated by reference.

In the embodiment shown in FIGS. 1-4, the filter unit 10 includes an outlet engagement protrusion 44 longitudinally extending away from the water receiving and emitting end 14 of the filter unit 10. The outlet engagement protrusion 44 has the outlet aperture 36 therein. The water receiving and engagement end 14 also includes an inlet engagement protrusion 46 extending away from the water receiving and emitting end 14 at a location offset from the outlet engagement protrusion 44. The inlet engagement protrusion 46 includes the inlet aperture 38 therein. The inlet and outlet engagement protrusions 44, 46 are configured to engage the inlet and outlet members of the filter head assembly upon longitudinal insertion of the filter unit into the filter head assembly. As such, it is conceivable that other embodiments may include alternative arrangements of the filter unit that are configured to engage with alternative filter head assemblies.

The filter media portion 20 is typically configured to filter and purify water that passes through the media wall 22. The media filter portion 20 may include one or more filter media such as carbon (e.g., activated carbon particles, such as mesoporous activated carbon, carbon powder, particles sintered with a plastic binder, carbon particles coated with a silver containing material, or a block of porous carbon); ion exchange material (e.g., resin beads, flat filtration membranes, fibrous filtration structures, etc.); zeolite particles or coatings (e.g., silver loaded); polyethylene; charged-modified, melt-blown, or microfiber glass webs; alumina; aluminosilicate material; and diatomaceous earth. The media material may also be impregnated or otherwise disposed on a porous support substrate, such as a fabric material, a paper material, a polymer screen, or other conceivable porous structures that may be contained in the permeable media wall 22 to filter and purify water. It is also conceivable that the filter media portion 20 may be configured to treat water that passes through the media wall 22, whereby the filter media portion may include a treatment media material configured to add a descaling agent to the water, add a vitamin to the water, add a mineral to the water, add a pharmaceutically active agent to the water, and add a color to the water, or mixtures thereof.

The filter media portion 20 is configured to include a service life based upon the types of media material contained therein. The service life may be quantified in the amount of water flow that optimally passes through the filter media portion 20 before the filtration, purification, and/or treatment effects of the media material deteriorate or no longer perform as desired or to the extent desired. The amount of time a filter media may deteriorate either prior to or after being initially exposed to any water flow may also be a factor in the service life of the filter unit. The service life of the filter unit configured to filter and purify water is typically at least about 50 to about 500 gallons, more typically about 100 to about 300 gallons and, even more typically 100 to 200 gallons, depending upon the frequency of use and the source water quality. The filter life may be up to about 500 gallons or 600 gallons depending largely on size of the filter and the nature of the filter media as well as the level of impurities in the water to be treated.

The filter unit 10, also typically includes a circular support structure 48 that is positioned in engagement with the second cap 34 to provide structural support. The second cap 34 typically includes a downwardly extending nozzle 50 that engages the interior passage 26. The distal end cap 52 engages the distal end of the body portion 12. The distal end cap 52 may threadably engage or permanently be bonded to the distal end of the body portion 12. Most typically, the distal end cap will be engaged to the body portion in manner that would be tamper evident, i.e. if one were to remove the distal end cap, it would be apparent to an end consumer. Alternatively, if one were to remove the distal end cap, the distal cap and/or body portion may be damaged, such that the distal end cap may not be reattached to the body portion 12. In this manner, it prevents tampering with the filter and identifies to the user whether or not tampering has occurred and/or whether or not the filter material may have been altered or replaced.

As shown throughout the figures, the present disclosure also generally includes a fluid flow impeding system 40 that may be placed at either end of the filter unit 10. As shown in FIG. 2, the fluid flow impeding system is positioned proximate the water receiving and emitting end 14, while FIG. 5 shows the fluid flow impeding system 40 positioned at the distal end of the filter unit 10.

Generally speaking, according to an aspect of the present disclosure, the fluid flow impeding system 40 includes the filter media engaging top cap 28 (shown in FIG. 2). The filter media engaging cap 28 engages one end of the filter media 20, but in FIG. 5, the filter media engaging top cap engages the second cap. In the case of FIG. 5, while not shown, a similar structure that engages the end of the filter media portion 20 proximate the water receiving and emitting end 14 typically would be utilized. The filter media engaging top cap 28 typically includes an upwardly extending nozzle 54 when the filter media engaging top cap engages the filter media; however, when positioned at the distal end, the nozzle 54 may be removed. The filter media engaging cap also typically includes a downwardly extending channel 56 that extends through a center aperture 58 of an impeller 60. The impeller 60 is typically seated within an impeller receiving cavity of an impeller housing 62. The impeller housing 62 also typically has an electronics receiving cavity 64 on a first side 66 and an impeller receiving cavity on a second, opposite side that is opposite the first side. The first side 66 and the second, opposite side 70 are typically divided by a dividing wall. The electronics assembly 72 is typically seated within the electronics receiving cavity 64 and any exposed electronic or power system information is typically encased within a non-toxic, water impermeable material 74. The electronics are “potted”, which is a process of filling an electronic assembly with a solid or gelatinous compound to exclude moisture. Thermosetting plastic, silicone or rubber gels may be used. Projecting downward and allowing water there through is a water impeding valve 76.

FIGS. 25-29 show an exemplary impeller housing 62 according to an aspect of the present disclosure. FIG. 27 shows the water flow path through the impeller receiving cavity. Water typically flows out of a side aperture 118. FIG. 28 shows the impeller positioned within the impeller receiving cavity 68 of the impeller housing 62. FIG. 29 shows an end cap 120 positioned over the impeller receiving cavity 68.

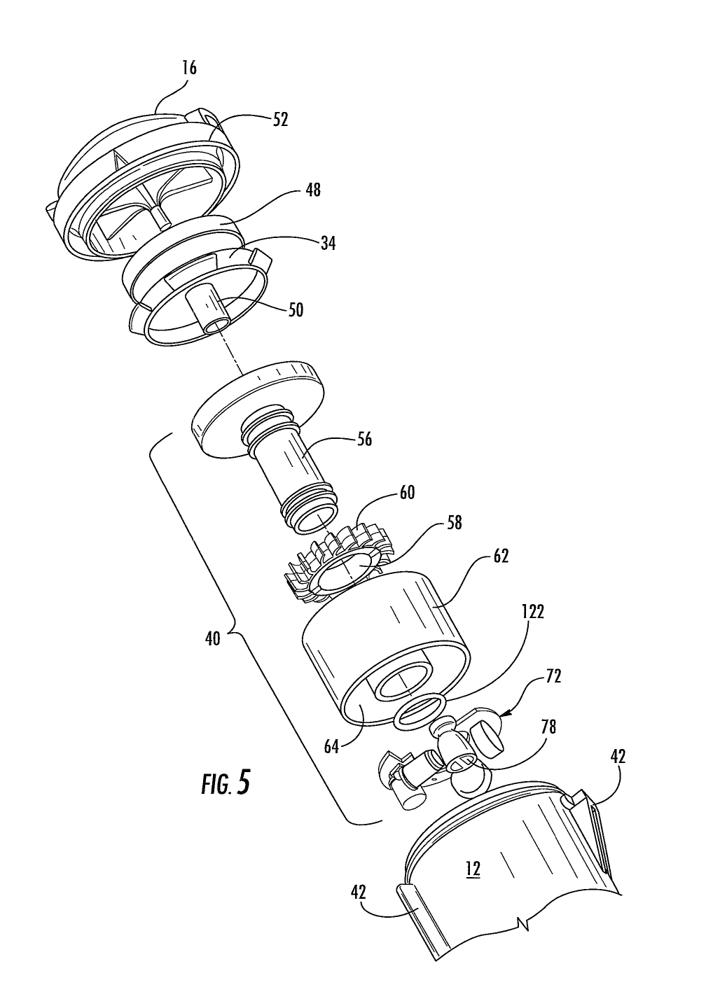

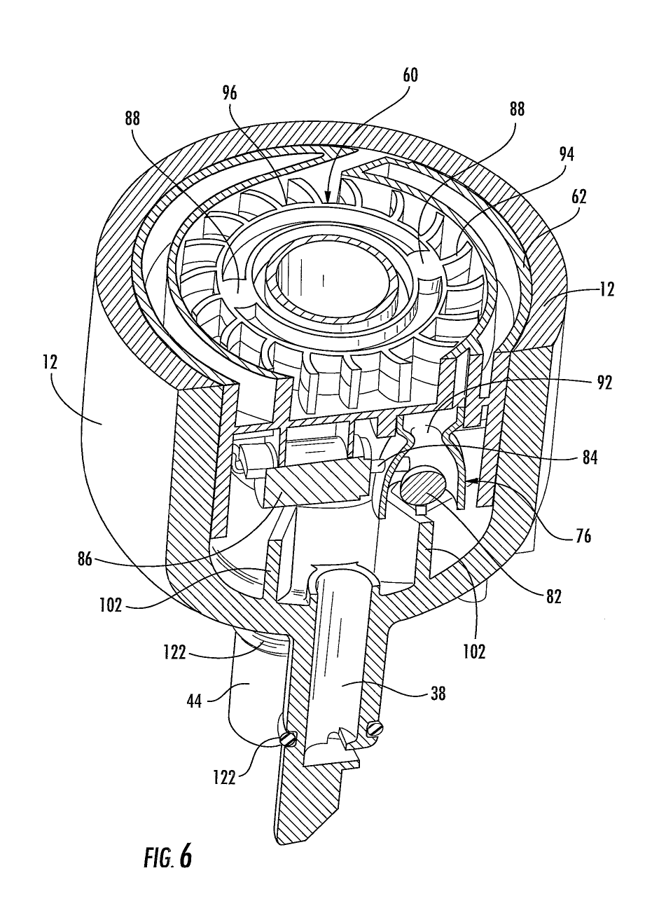

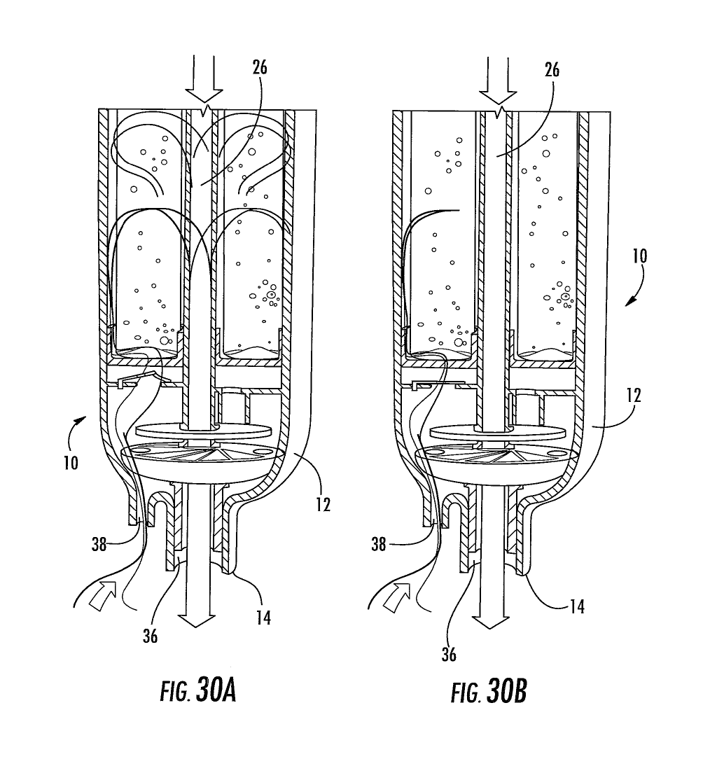

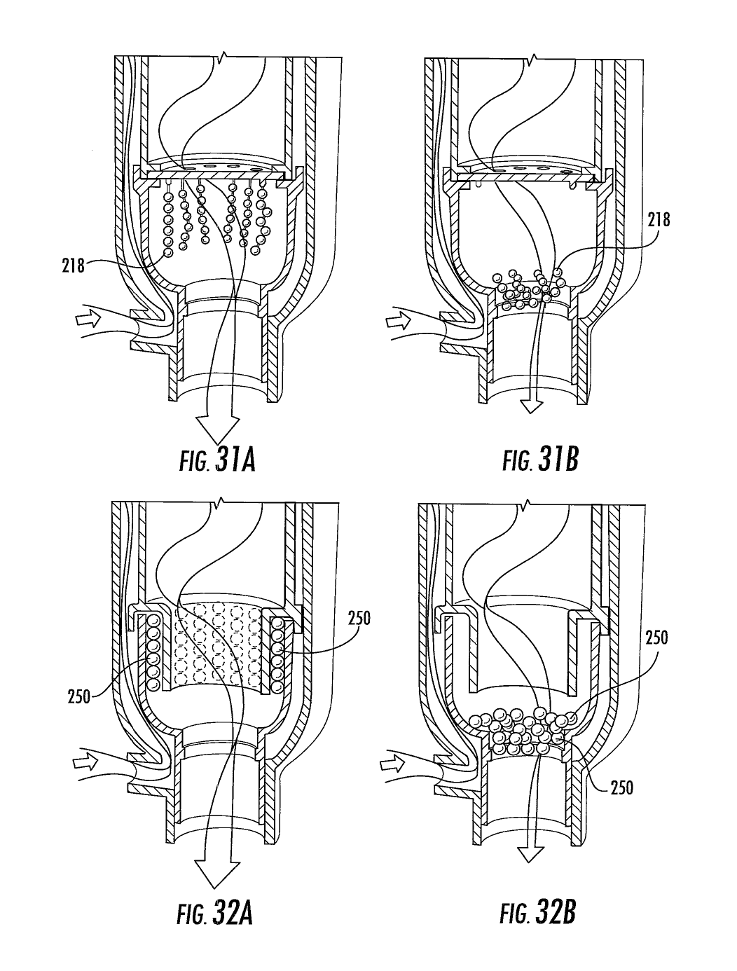

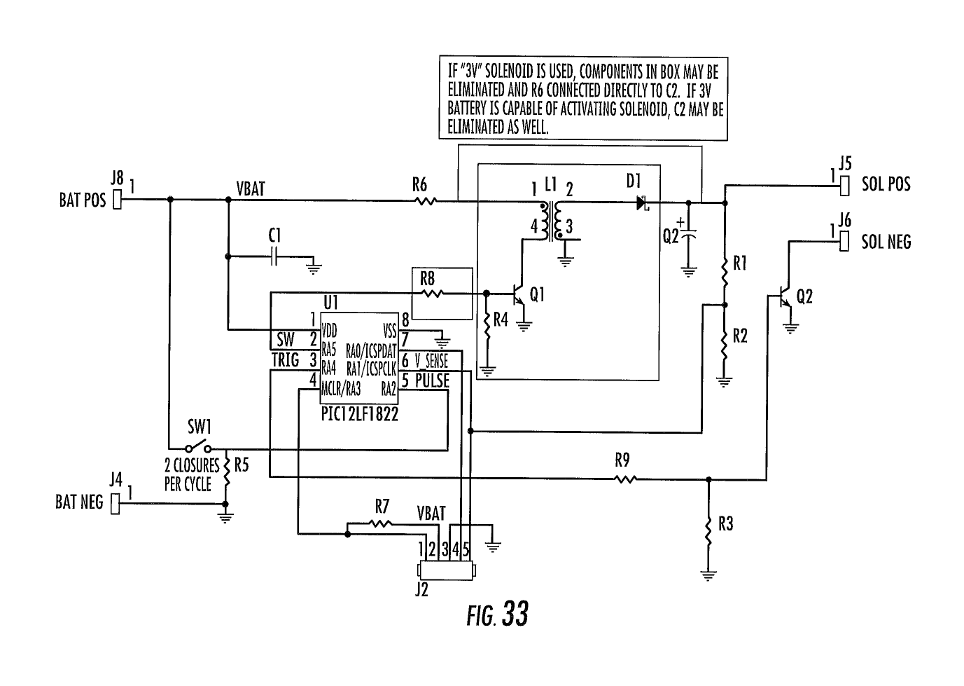

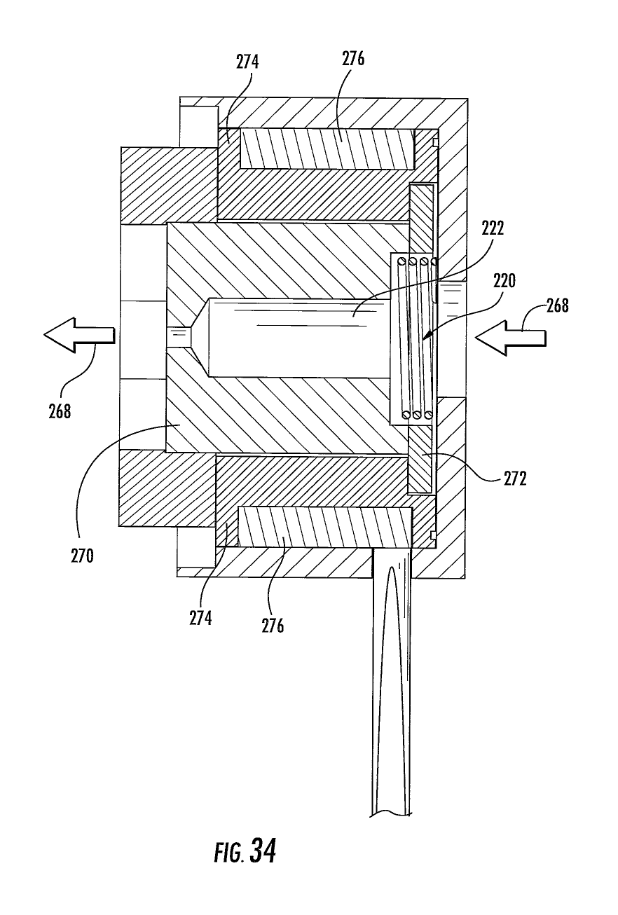

The water impeding valve 76 of the fluid flow impeding system 40 typically has an inlet side 78 and an outlet side 80 and is typically positioned in parallel with the central axis of the filter unit; however, numerous shapes and configurations of the valve 76 may be used. Within the water impeding valve is typically a water impeding object 82. A spherical member may be the water impeding object, but the water impeding object, for example, may also be one or more of the following: an impeller 60 held stationary by a signal activated breaking mechanism such as a solenoid driven pin driven in between that radially outwardly extending water engaging water engaging fins 94; a plurality of metal debris or metal beads (FIGS. 32A and 32B); a flap valve (FIGS. 30A and 30B); a plurality of beads (FIGS. 31A and 31B) and/or a spring-biased stop or other spring-biased water impeding object (FIGS. 21A and 21B). When the water impeding object is a spherical member as shown in FIGS. 6-10, the sphere is typically retained by the retaining member 84, which is typically a retractable pin. The retractable pin is operably associated with a solenoid 86.

FIGS. 6-10 and 22-24 show the embodiment employing a solenoid and retaining member. In operation, water flows from the water within the impeller housing inlet aperture 38, past the spherical member and into engagement with the impeller 60 thereby spinning the impeller. The impeller 60 typically has one or more magnets 88 enclosed within or positioned on a portion of the impeller. The magnet or magnets 88 operate to communicate with a reed switch that is a component of the electronic's assembly 72 to count or track each time the magnet(s) pass over the reed switch. This allows the filter unit 10 to determine how much (the volume of water) water follows through the filter unit 10.

When the volume of water following through the filter unit 10 surpasses or is approximately the maximum volume capable of being effectively treated by the filter media portion 20, typically a sufficient charge has accumulated in a capacitor 90 of the electronic assembly such that the solenoid is activated or the solenoid itself is activated without the use of a capacitor and the retaining member 84 is retracted by the solenoid. Once the retaining member has been retracted, the water impeding object 82 (spherical member) is allowed to flow along with the water flow flowing through the water impeding valve and moves into engagement with an internal bottleneck portion 92 of the typically hourglass-shaped water impeding valve. As a result, the water flowing through the filter unit 10 is slowed or stopped. Typically, water is allowed to flow through at an approximately 75 to 80% reduced rate from the water flow rate prior to activation of a solenoid and the retracting of the retaining member 84.

The impeller 60 typically has a plurality of water engaging fins 94 that radially extend away from a central hub 96. The water engaging fins are typically curved to capture water flowing through the filter 10 and allow for rotational movement of the impeller in the cylindrical housing of a cylindrically shaped impeller housing 62. Essentially the fins are arcuate wall members. While not shown, the fluid flow impeding system shown in FIGS. 6-10 and 22-24 may include one or more water flow channels that are not a water impeding valve. When used, the water flow channels that are not in the water flow path of the water impeding valve ensure that the entire flow of water is not blocked by the spherical member. Rather, depending on the size of the aperture(s) of the water channel(s), a regulated percentage of water less than the normal flow rate will still flow through the filter unit 10.

As discussed above, one or more magnets 88 communicate with a reed switch, which is part of a single sided surface mount circuit board, which is typically approximately 0.032 inches thick. A reed switch should be in signal communication with the magnet such that the reed switch reads each time the magnet passes over the read switch. As a result, an accurate assessment of the volume of water passing through the filter unit 10 may be made by the filter unit.

As shown in FIGS. 7 and 8, the impeller housing 62 typically has an integral polypropylene “V” seal 97 that creates an interference seal between the interior side of the body portion 12 and the impeller housing. The “V” seal operates to force water to pass through the impeller. As also shown in FIGS. 7 and 8, a quattro seal 98 is employed to engage the downwardly extending channel 56 to the body portion 12 of the filter unit 10. A quarto seal is a four-lobbed seal with a geometry that provides twice the number of sealing surfaces than a standard O-ring. The quarto seal utilizes squeeze and deflection to affect a seal. The second cap 34 also typically includes integral “V” sealing members 97 positioned circumferentially about the perimeter of the second cap 34.

As shown in FIG. 9, the electronic assembly 72 of the present disclosure typically includes at least one battery 100. The battery or batteries operate to provide power to the printed circuit board processor and the capacitor. Alternatively, a turbine may be used instead of or in addition to a battery and capacitor to provide the activating electrical power to the other component of the systems of the present disclosure such as the solenoid. Preferably, all of the electrical components are kept on one side of the printed circuit board.

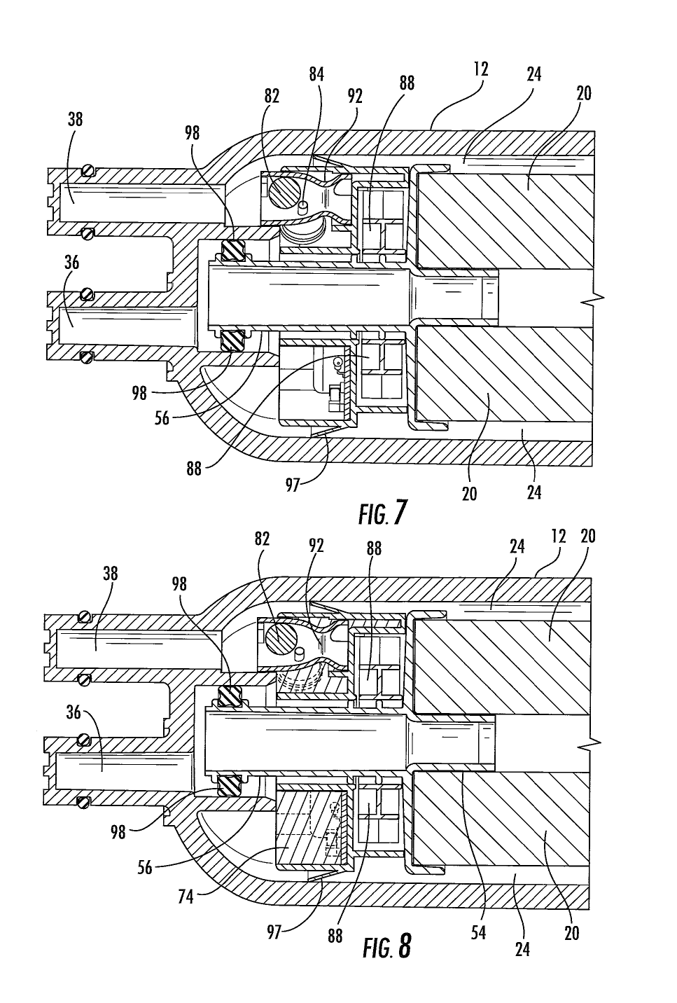

The water impeding valve 76 (see FIG. 10) is typically positioned in between a plurality of ribs 102. The ribs 102 provide structural support. The water impeding valve may also be a funnel shape that fits between the ribs. As shown in the drawings, the water impeding valve is typically substantially hourglass-shaped.

As shown in FIGS. 14-18, the impeller 60 can have various configurations. As shown in FIG. 16, the impeller may be molded such that the magnets are molded within the impeller when the impeller is made of one or more plastic materials. As shown in FIG. 17, the impeller may include a low friction axle 102. FIG. 17 shows magnet receiving apertures 104. The magnets are affixed or molded into the magnet receiving aperture(s) 104. The magnets may be attached via an appropriate adhesive.

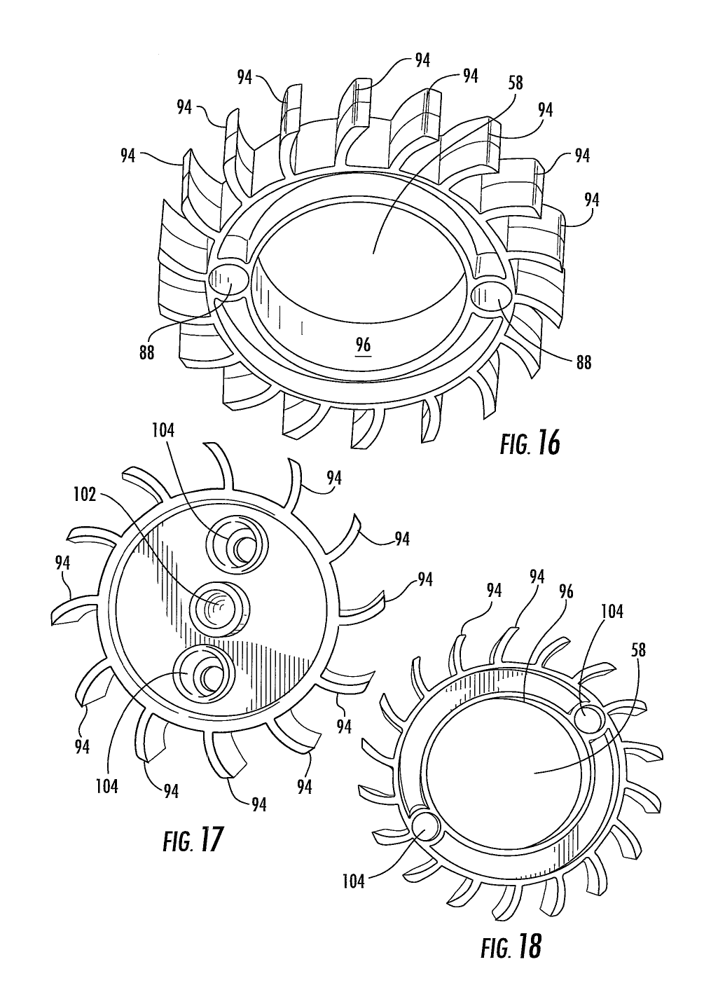

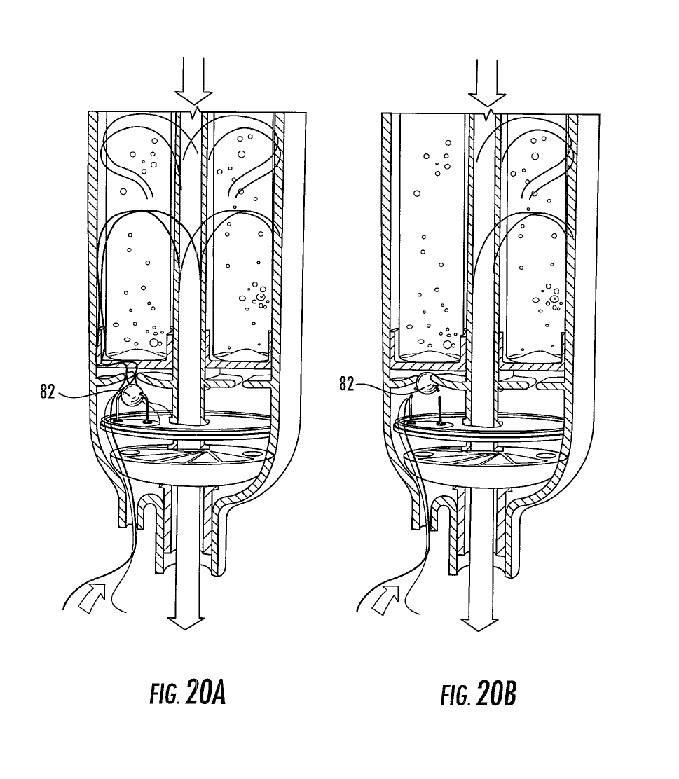

As shown in FIGS. 19A-D, various valve seats may be used in connection with the systems of the present disclosure. The valve seats may receive the spherical member or other water impeding object(s) and are typically designed to have the spherical member block the majority of the water flow while allowing some water flow to continue through the valve seats. As shown in FIG. 19A, the spherical member 82 would eventually be seated within the funnel portion 106b of the valve seat inserts 108a. Similarly, the spherical member would be received into the funnel portion 106 of the valve seat 108b shown in FIG. 19B. The valve seat 108c and 108d have a substantially planar spherical member receiving surface 110. As can be seen, there are typically alternative water flow paths that would not be blocked if a spherical member were brought into engagement with the planar surfaces. For example, in FIG. 19C the peripheral water channels 112 would not be blocked by the spherical members when brought into engagement with the primary center channel 114. Water flow would still be permitted through the valve seat insert. However, a majority of the water flow would be blocked thus slowing the flow of water through the filter assembly and the flowed water being dispensed to the user.

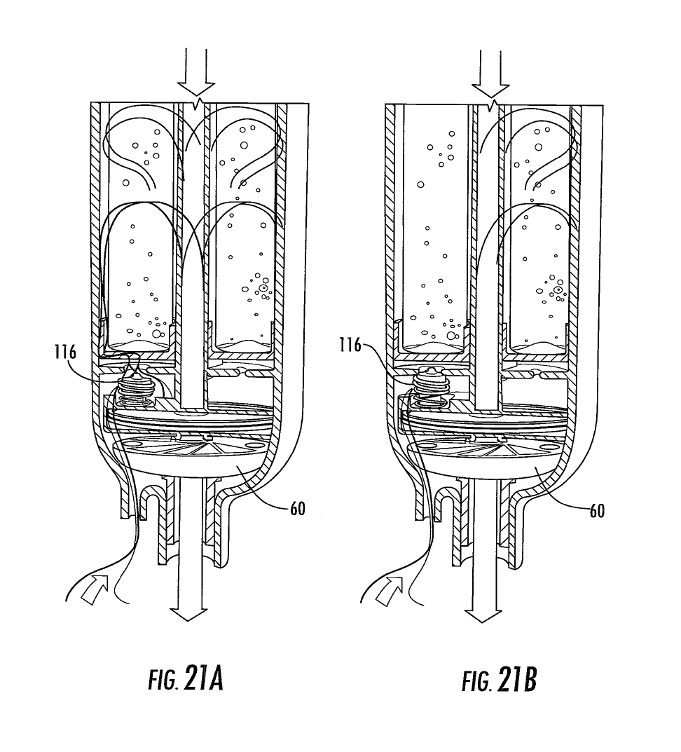

In another aspect of the present disclosure shown in FIGS. 20A and 20B, the electronic assembly 72 operates in the same manner as discussed above. Mainly, the impeller communicates with the reed switch. The capacitor charges to a predetermined level. Once the predetermined level of charge is reached, which corresponds the useful life of the filter media portion of the filter unit, the capacitor discharges and breaks the wire connection (see FIG. 20A) such that the spherical member 82 is allowed to be forced by water flow into engagement with a water flow aperture (see FIG. 20B) and block one of a plurality of such water flow apertures. In this manner, while a majority of water is blocked, some water is still permitted to flow thereby creating a slowed water flow rate.

Yet another aspect of the present disclosure is shown in FIGS. 21A and 21B. These figures show a spring biased impeding object 116 that is biased toward an engaged position and held in a disengaged position with a wire engagement in a similar manner as shown in FIGS. 20A-B. Again, once a predetermined electrical change has been reached after the volume of water that may be effectively treated by the filter unit has passed through the filter unit, the capacitor discharges and releases the spring bias member to block the water passage.

FIGS. 31A and 31B show an alternative fluid impeding system employing utilizing a plurality of suspended strands of beads 218 prior to release (FIG. 31A) and after triggering of the fluid impeding system (FIG. 31B), which results in a slowed water flow through the filter. Once triggered after a predetermined electrical charge has been reached and after the volume of water that may be effectively treated by the filter unit has passed through the filter unit, the capacitor discharges and releases the strands of beads and water flow is inhibited.

FIGS. 32 and 32B show yet another fluid impeding system. The system shown uses a plurality of magnetic beads 250, typically metallic, spherical beads, or other debris that engages a magnet to permit initial “normal” water flow (FIG. 32A) and are disenganged/released form the magnet to inhibit water flow (FIG. 32B). The magnet holding the spherical beads may be an electromagnet that is deactivated once a predetermined electrical change has been reached after the volume of water that may be effectively treated by the filter unit has passed through the filter unit. The deactivation releases the magnetic beads.

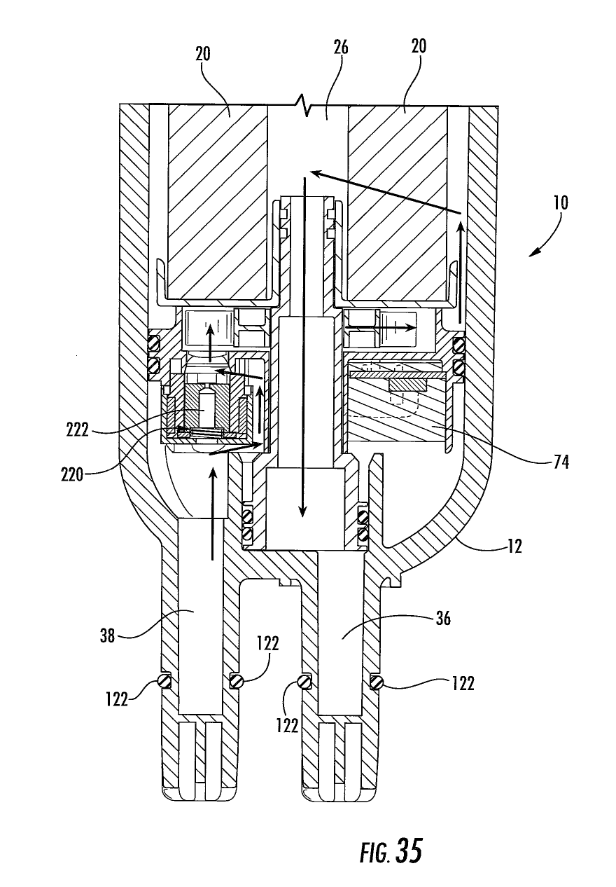

FIG. 33 shows how the S-t-F circuit shown might utilize a “3 volt” solenoid. The components in the step-up circuit (boxed) can be removed, and the battery connected directly to the energy storage capacitor, C2, through a current limiting resistor, R6. C2 is now charged to 3V (instead of something more than 5V) and may need to change in value, depending on the energy required to activate the 3V solenoid. If the battery is capable of supplying the necessary current (this translates to the battery's internal resistance being low enough), it may be possible to eliminate C2, and use the battery to activate the solenoid directly. The purpose of R6 is to prevent the solenoid (or step-up circuit, if used) from dropping the battery voltage to zero, which would reset the microprocessor.

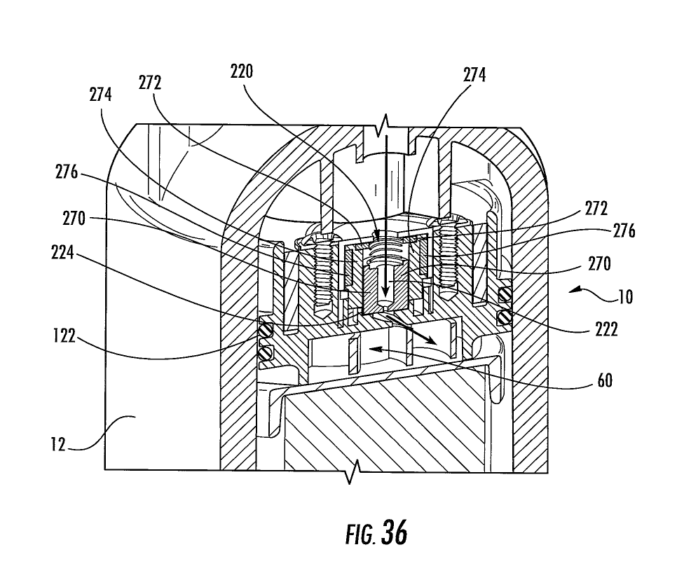

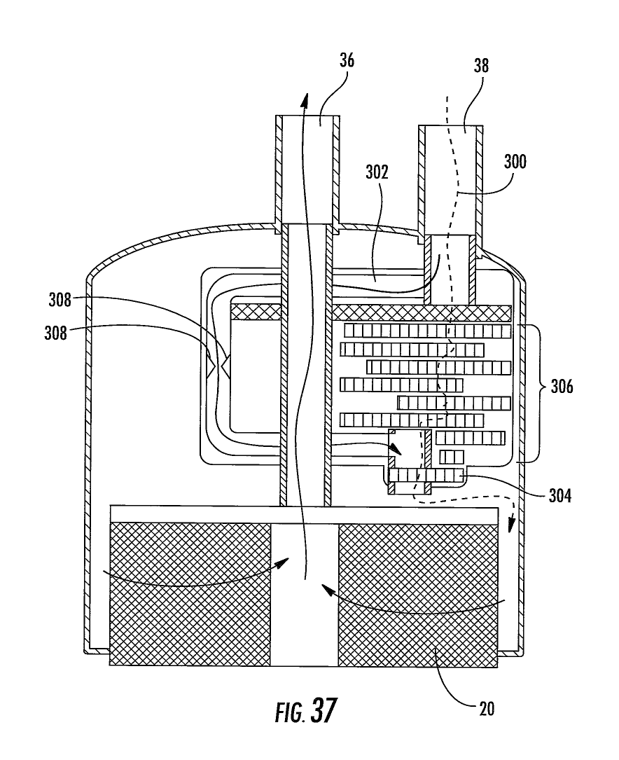

FIGS. 34-36 show another fluid impeding system that uses a solenoid 220 that releases the plunger/peg 222 once a predetermined electrical change has been reached after the volume of water that may be effectively treated by the filter unit has passed through the filter unit, the capacitor discharges and releases the plunger 222. The plunger sits inside a raised ring 224. Water is then restricted via a small (0.5 mm diameter) hole in the plunger. Prior to the seating of the plunger, water is allowed to freely flow underneath the plunger. FIG. 34 shows an enlarged view of the fluid impeding system of this embodiment. Water flows through the system in the direction of the arrows 268, FIG. 34, and the arrows shown in FIGS. 35-36. The core 270, magnet 272, bobbin 274 and winding 276 are shown.

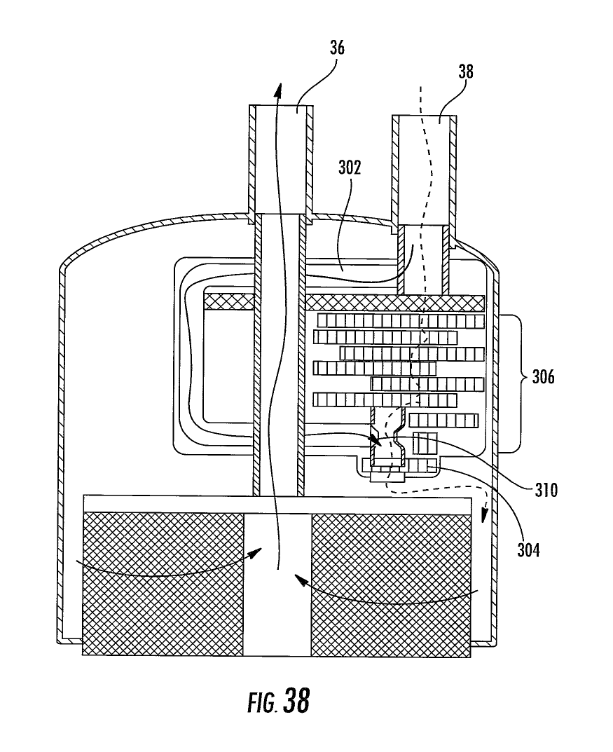

As shown in FIGS. 37-40B, an alternative flow by-pass and triggering mechanism is shown. Gearing systems within water filters with a capacity of greater than about 50 gallons where the gearing system measures or approximates filter life have generally not been employed due to the tremendous complexity of such systems. However, the present disclosure incorporates, as shown in FIGS. 37-38, a flow by-pass system. A significant amount of water by-passes the impellers of a gear-based flow totaler assembly. This allows the gear assembly to turn much slower compared to a configuration utilizing the total water flow. This reduces the number of gears in the total gear assembly, which simplifies the design, increases reliability, and reduces cost. This configuration also reduces the volume of internal space within the filter utilized by the gear assembly.

A manifold with more than one outlet is employed where the outlet is at a given hydraulic system static pressure. The manifold would not have to have a balanced flow but merely consistent flow where, for example, 90% of the water flow could travel a main water flow path 300 and 10% would travel a secondary flow path 302, which is rotated through the turbine wheel of the flow totaler 304. The secondary flow path will have a minority of the water flow flowing through it, but more typically significantly less than 50%, as discussed above. This reduces the gear train stack 306 required to count the total flow of the water filter to only a small percentage. This reduces the number of stages and fineness of the gear teeth required for approximately 10× flow volume if the total flow has to be directed entirely through the flow totaling mechanism.

FIG. 37 shows a cut-away of a refrigerator water filter with the gear-based flow totaler in place. The water inlet flows through a turbine wheel that drives the timing and gear train. In turn, the gear train, as the flow total is achieved, closes off a discharge port to stop or reduces total flow in order to signal to a user that the end of the filter life has been reached. The schematic view shows a flow by-pass of the flow totaling mechanism. The by-pass allows a range of total flow coming into the filter inlet from about 5% to about 85% with the intent that the majority of flow would by-pass the flow totaler. However, a certain amount of flow may be required to drive the totaler mechanism and, as such, a balancing restriction 308 could be set into the by-pass as indicated by the narrowing in the by-pass flow cross-section. This restriction could be accomplished in a variety of ways by simply choosing an appropriate length and diameter of the by-pass, by introducing a flow washer or other flow restrictor or by pinching of the tube diameter as shown in FIG. 37. Additionally, to assist in more consistent flow regulation over a range of inlet pressures, the by-pass could employ a venturi 310 in the mechanism flow path that would set up a pressure differential for the by-pass (see FIG. 38).

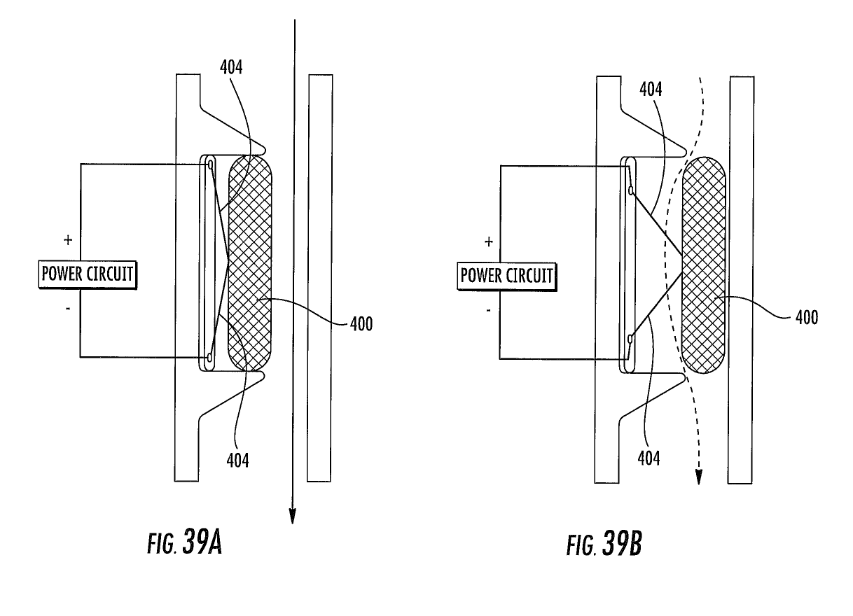

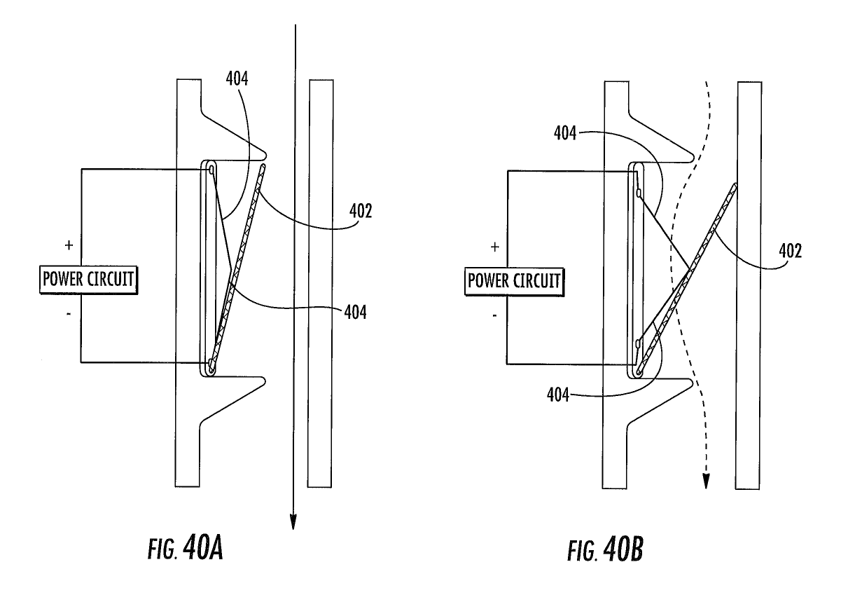

In addition to using the by-pass totaling mechanism to calculate when to initiate a flow restriction mechanism, the disclosure contemplates the use of a shape memory plunger as a flow restriction mechanism. As shown in FIGS. 39A-40B, the shape memory plunger changes the water filter flow resistance by employing a shape memory component in one state not imposing any geometry that would impede water flow and in a deployed state (energized to go to a trained shape) the component would provide a pinch point or move a plug or plunger to the flow stream thereby increasing flow resistance. Care is typically needed to ensure the shape memory alloy is out of the water flow so that heat required to activate the trained state is not excessive in order to overcome the cooling effect of any water. Thus, the shape memory alloy could be encased in a loosely fitting membrane cloak or bag (not shown). Additionally, the force of the shape memory alloy needs to be minimal and the force generated is primarily used to provide total or substantial blockage of the main flow path. As shown FIGS. 39A-40B, a plug 400 or gate 402 could be moved into the flow path but consideration needs to be made to ensure the force does not have to overcome substantial fluid flow or restriction forces. To avoid fluid momentum forces, the trigger could be fired once flow has stopped or the plug shaped so that initial flow impingement would aid to drive the flow blocking plug into place in the main flow path. Thus, instead of being streamline such as the plug shown in FIGS. 39A and 39B, instead the plug could be a perforated plug. As shown in FIGS. 40A and 40B, once tipped into the flow field by the deployed shape memory alloy 404, is then driven by the flow into a blockage position held lightly in place by the deployed shape memory alloy, but firmly by water flow during water filter dispensing. The shape memory alloy 404 would typically require a one-time firing of a power circuit upon the determination of the appropriate flow volume for the filter. Once the total capacity of treated water has been reached, the triggering mechanism fires and the shape memory alloy moves the water flow impingement mechanism into position. This slows the flow of the water being dispensed to the user out of the appliance, typically a refrigerator, and indicates to the user that the useful life of the filter has been reached.

The shape memory alloy may be a shape memory alloy produced by Dynalloy, Inc. of Irvine, Calif. The shape memory alloy is typically a wire capable of repeatable motion. The wire can typically contract from about 3% to about 5% of its length upon activation, which is achieved by heating the wire with electricity.

The shape memory alloy would typically need to be sealed from contact with water due to the fact that the action of the shape memory alloy is driven by heat, which would be dissipated by water contacting the alloy. As such, the system of the present disclosure would have the alloy link sealed on at least one end of a water tight enclosure. The seal on the end is typically constructed to be breakable when the alloy is activated. A cap made of a folded membrane such as a thin silicone sheet material might be used. The silicone sheet would typically be constructed to unfold upon breakage of the link occurring on activation of the alloy. Alternatively, a very low durometer material may be applied to the system such that it slides or extends when the link breaks.

In another system, a water flow reduction system might employ a dissolvable material, such as a polymer that is NSF 61 safe and typically would not add taste, color or odor to the drinking water, and a non-dissolvable plastic part. As the dissolvable material gradually erodes, the non-dissolvable material/plastic would be release to block or slow the flow of water through the system/filter.

In yet another aspect of the present disclosure shown in FIGS. 41-43, a fuseable underwater valve actuator is shown. This aspect incorporates an elongated chamber that insulates a portion of the fuse wire from the flow of water, which operates to lower the level of power that needs to be supplied to break the fuse wire after the useful life of the filter has passed. The fuse may be actuated during a period of water flow, but could also be actuated during a period of non-water flow. The figures, a clam shell housing 500 encases the fuse 502 in a watertight manner. The fuse 502 is typically surrounded by a low thermal mass, non-electrically conductive, thermally insulation material 504, which is most typically air, but could also be a solid material such as a plastic or a foam insulation material. The fuse wire extends through an end 506 of the housing 500. The end 506 is proximate the plug ball 508 and has an easily rupturable plug 510. The fuse wire extends through the plug 510 and engages the plug ball 508 to retain the plug ball in the disengaged position that does not slow or stop the flow of water. As in previous embodiments, once the useful life of the filter has passed, the electrical charge, which can be significantly less than in other embodiments where the fuse is in contact with water that acts as a heat sink, breaks the fuse wire. When the fuse wire breaks, the plug ball 508 is released and settles into contact with the valve seat 512. The valve seat typically has a plurality of radially inwardly extending support spokes 514 that define a series of water flow segment 516. The plug ball 508 is of sufficient size to substantially impede, but typically not completely block water flow through the water flow segments 516 after the plug ball 508 is released by the fuse wire.

The clam shell housing is typically mounted and engaged with a series of support spokes 518. A ring-shaped base 520 and anchor legs 522 extending therefrom may be used to further support the clam shell housing in position. These components may be affixed or molded into the plastic components of the system. Conceivably, the clam shell housing could be other shapes than the elongated tubular shape as shown, including cuboid-shaped, and spherical. Additionally, other anchoring elements (not shown) may be used in connection with this aspect of the present disclosure such as anchoring systems that engage a distal end 524 of the housing 500 and/or along the middle portion of the housing 500. This aspect of the present disclosure does not require and typically does not use a solenoid or other electrically powered component to trigger the fuse wire.

It will become apparent to those skilled in the art that various modifications to the preferred embodiment of the disclosure as described herein can be made without departing from the spirit or scope of the disclosure as defined by the appended claims.

What is claimed is:

1. A method of indicating to a user of an appliance that a water filter unit operably connected to the appliance has passed its useful life comprising the steps of:
providing a filter unit and wherein the filter unit comprises a fluid flow impeding system within a housing of the filter unit;
engaging the filter unit with the appliance in a manner such that water received into the appliance from an exterior water source from the appliance enters the filter unit through an inlet aperture and filtered water is delivered out an outlet aperture;
measuring the volume of water treated by the filter unit using an end of life measuring system positioned within the filter unit wherein the end of life measuring system comprises a by-pass water line that diverts a minority portion of the water received by the filter unit from the exterior water source into engagement with a gear train system that is operably engaged with a fluid flow impeding device; and
activating the fluid flow impeding device contained within the housing of the filter unit after a maximum volume of water the filter unit has been designed to treat has been surpassed.

2. The method of claim 1, wherein the fluid flow impeding device is a flow cutoff/reduction valve operably connected to the end of life measuring system and wherein the method further comprises the step of indicating to a user that the maximum volume of water the filter unit has been designed to treat has been surpassed and the filter unit should be replaced by thereafter slowing the flow of water from the dispenser of the appliance.

3. The method of claim 1, wherein the fluid flow impeding device is operably connected to a shape memory alloy containing mechanism wherein the shape memory alloy member is activated after a predetermined volume of water has passed through the water filter and the method further comprises the steps of: activating the shape memory alloy to provide a contraction force; and moving the water impeding element from a full water flow position to a water impeding position using the contraction force of the shape memory alloy after the maximum volume of water the filter unit has been designed to treat has been surpassed by electrical activation of the shape memory alloy.

4. The method of claim 1, wherein the end of life measuring system is free of any electrically powered component and about 10% or less of the water flowing through the inlet aperture flows through the by-pass water line.

5. The method of claim 3, wherein the water impeding element is a moveable plug.

6. The method of claim 5, wherein the moveable plug is solid.

7. The method of claim 3, wherein the water impeding element is a perforated plate positioned within the water flow path of the water filter after the fluid flow impeding device has been activated.

8. The method of claim 1, wherein the outlet aperture is an outlet aperture of a water dispenser of an appliance that delivers filtered potable water to the user.

9. The method of claim 8, wherein the end of life measuring system is free of a solenoid used to activate the fluid flow impeding device.

10. The method of claim 1, wherein the end of life measuring system is free of a solenoid used to activate the fluid flow impeding device.

11. The method of claim 10, wherein the water filter has a useful life capacity such that the filter is able to filter greater than 50 gallons of unfiltered municipal water prior to losing its efficacy.

12. The method of claim 11, wherein the water filter has a useful life capacity such that the filter is able to filter greater than 400 gallons of unfiltered municipal or known microbiologically safe water prior to losing its efficacy.

13. The method of 11, wherein the water filter has a useful life capacity such that the filter is able to filter greater than 200 gallons of unfiltered municipal or well water prior to losing its efficacy and wherein the water filter comprises an activated carbon filtration media that reduces chlorine, taste and odor components (CTO) per NSF 42 and NSF Standard 53 to a minimum of 200 gallons.

14. The method of claim 13, wherein the outlet aperture is an outlet aperture of a water dispenser of an appliance that delivers filtered potable water to the user.

15. The method of claim 14, wherein the by-pass water line comprises a balancing restriction system positioned therein to ensure substantially constant water flow through the bypass water line.

16. A filter unit comprising:
a substantially cylindrically shaped main body portion having a distal end portion and an engaging end portion configured to engage a water source and receive water from the water source through a water inlet aperture and deliver treated water out of the filter unit through a water outlet aperture; and
a fluid flow impeding system positioned in at least one of (1) the distal end portion or (2) the engaging end portion of filter unit; and
wherein the fluid flow impeding system is spaced within the main body portion such that water passing from the water inlet aperture and out the water outlet aperture passes through the fluid flow impeding system and the fluid flow impeding system is configured to be activated after a predetermined volume of water has passed through the fluid flow impeding system and thereafter position a fluid flow impeding object into the water flow and thereby slow the flow of water through the water impeding valve to a rate less than the normal flow rate and after the predetermined volume of water has passed through the fluid impeding system and wherein the fluid flow impeding system comprises a gear based flow totaler assembly that comprises a gear stack in operable connection with a diverted water flow within a diverted water flow pathway that is a minority of the water flowing through the main water flow pathway in the filter where the minority of water flowing through the main water flow pathway and the gear stack are configured to measure when the effective useful life of the filter unit has been surpassed.

17. The filter unit of claim 16, wherein about 10% or less of the total water flowing from the water inlet is diverted through the diverted water flow pathway.

18. The filter unit of claim 17, wherein the end of life measuring system is free of any electrically powered component; and the water filter has a useful life capacity such that the filter is able to filter greater than 400 gallons of unfiltered municipal or well water prior to losing its efficacy.

19. An appliance comprising:
at least one freezer compartment;
at least one fresh food compartment;
an exterior water connection that provides water from outside the appliance to the appliance;
a filter unit; and
a filter head assembly configured to receive a filter unit wherein the filter unit is configured to be engaged and disengaged with the filter head assembly by hand and without the use of tools; and
wherein the filter unit comprises:
a main body portion having a distal end portion and an engaging end portion configured to engage a water source and receive water from the water source through a water inlet aperture and deliver treated water out of the filter unit through a water outlet aperture; and
a fluid flow impeding system positioned in at least one of (1) the distal end portion or (2) the engaging end portion of filter unit; and
wherein the fluid flow impeding system is engaged with an interior wall of the main body portion such that water passing from the water inlet aperture and out the water outlet aperture passes through the fluid flow impeding system and the fluid flow impeding system includes a gear based flow totaler assembly that comprises a gear stack in operable connection with a diverted water flow within a diverted water flow pathway that is a minority of the water flowing through the main water flow pathway in the filter where the minority of water flowing through the main water flow pathway and the gear stack are configured to measure when the effective useful life of the filter unit has been surpassed; and
wherein the water filter has a useful life capacity such that the filter is able to filter greater than 200 gallons of unfiltered municipal or well water prior to losing its efficacy and wherein the water filter comprises an activated carbon filtration media that reduces chlorine, taste and odor components (CTO) per NSF 42 and NSF Standard 53 to a minimum of 200 gallons and wherein the fluid flow impeding system and the gear based flow totaler are each free of any electronically powered component.

20. The appliance of claim 19, wherein the water filter has a useful life capacity such that the filter is able to filter greater than 400 gallons of unfiltered municipal water prior to losing its efficacy.
